(19) United States
(12) Patent Application Publication
(10) Pub. No.: US 2025/0230979 A1
(43) Pub. Date: Jul. 17, 2025

(54) HEATING ELEMENT FOR TIMBER DRYING DEVICE AND TIMBER DRYING DEVICE USING SAME

(71) Applicant: Seungsuk LEE, Yongin-si (KR)

(72) Inventor: Seungsuk LEE, Yongin-si (KR)

(21) Appl. No.: 18/845,092

(22) PCT Filed: Jul. 17, 2023
(86) PCT No.: PCT/KR2023/010191

§ 371 Date: Mar. 27, 2025

(30) Foreign Application Priority Data
Oct. 28, 2022 (KR) 10-2022-0140911

(51) Int. Cl. F26B 23/06; B27K 5/00; F26B 3/20; F26B 25/18

(52) U.S. Cl. CPC F26B 23/06; B27K 5/001; F26B 3/20; F26B 25/185; F26B 2210/16

(57) ABSTRACT

The present invention relates to a heating element for a timber drying device and a timber drying device using same, the heating element comprising: a concave and convex metal plate sandwiched between vertically laminated timbers and having ridges and valleys alternately formed thereon; heating cables generating heat as power is applied thereto; and a plurality of heat transfer pipes which are tightly coupled to the concave and convex metal plate between the ridges and valleys of the concave and convex metal plate to reinforce the strength of the concave and convex metal plate and into which the heating cables are sequentially inserted to transfer heat generated from the heating cables to the concave and convex metal plate. According to the present invention, with a very simple structure, heat can be transferred evenly throughout the timbers, the heat conduction efficiency from the heating cables to the concave and convex metal plate can be greatly improved, the lifespan of the heating element can be significantly extended, and the convenience of a timber laminating work for timber drying can be greatly improved.

### TECHNICAL FIELD

The present invention relates to a heating element for a timber drying device and a timber drying device using the same, and more particularly, to a heating element for a timber drying device and a timber drying device using the same to evaporate and dry moisture contained in a timber so as to prevent a product formed of the timber from deforming or cracking.

### BACKGROUND ART

In general, a wood (timber) has a relatively high moisture content. Thus, when a product is manufactured by using the wood as it is without sufficient dry, deformation occurs on the product as the wood dries over time. Therefore, a drying process for evaporating moisture to dry wood is required before the wood is used to produce the product.

A scheme for drying wood includes a natural drying scheme and a heat drying scheme. The natural drying scheme refers to a scheme of stacking wood on a drying field and drying the wood using the temperature, humidity and wind of the air. The facility costs are low and the work is relatively simple, however, a time required for drying is long, a wide drying site is required, and a drying is not allowed below an air-dried moisture content. Meanwhile, the heat drying scheme refers to a drying scheme for artificially controlling drying conditions such as temperature, humidity and wind speed in a drying chamber, and there are the advantages in that a time required for drying is relatively short and the dry is allowed below the air-dried moisture content.

A device used in the heat drying scheme includes, for example, a device for heating internal air by directly installing an electric heater inside a drying chamber, a device for injecting heated air into a drying chamber through a hot air blower that obtains heat from a combustion device, a device for indirectly heating air inside a drying chamber by heating a heat medium in a combustion device and then injecting the heat medium into a drying chamber, a device for injecting superheated steam into a drying chamber, and a high-frequency vacuum drying device for drying wood inside a vacuum chamber by generating heat with high frequency.

However, for the heat drying scheme as described above, costs for purchase and installation of the device are excessively required, and the high power high frequency is required to be generated while maintaining the drying chamber in a vacuum state. Accordingly, the operating cost of the high frequency vacuum drying device may be burdensome, the device may always be exposed to risks such as electric shock and fire, and the efficiency of converting electrical energy into heat energy through a high-frequency generator may be low, thereby requiring excessive operating costs.

For a wood drying device to solve the above problems, Korean Patent Registration No. 10-20622351 (Registered on Dec. 27, 2019) discloses “MOVABLE WOOD DRYING DEVICE EQUIPPED WITH SURFACE HEATING ELEMENT AND DRYING METHOD”.

The above conventional wood drying device using a general surface heating element as a heating tool may minimize a surface cracking phenomenon since the wood is dried from the inside, may enable low equipment purchase and installation costs and high energy efficiency, may be manufactured with inexpensive materials, and may be manufactured lightweight.

However, according to the conventional wood drying device using the general surface heating element, the surface heating element may not have a uniform temperature, a risk of fire may exist when the temperature rises locally in a portion of the surface heating element, and moisture emitted from the wood may not be effectively discharged since the surface heating element and the wood are configured to come into continuous contact with each other.

Further, documents disclosing the technology related to wood drying include: Korean Patent Registration No. 10-2397995 (May 10, 2022), Korean Patent Registration No. 10-2062351 (Dec. 27, 2019), Korean Patent Registration No. 10-1430031 (Aug. 7, 2014), Korean Patent Registration No. 10-1434472 (Aug. 20, 2014), and the like.

### DISCLOSURE

### Technical Problem

An object of the present invention is to provide a heating element for a wood drying device and a wood drying device using the same such that, with a very simple structure, heat can be transferred evenly throughout the woods, and the heat conduction efficiency from the heating cable to the concave and convex metal plate can be greatly improved.

Another object of the present invention is provide a heating element for a wood drying device and a wood drying device using the same, such that the lifespan of the heating element can significantly extend, and the convenience of a wood stacking work for drying the woods can be greatly improved.

### Technical Solution

To this end, the present invention proposes a heating element for a wood drying device, which includes a concave and convex metal plate sandwiched between vertically stacked woods and having ridges and valleys alternately formed thereon; a heating cable for generating heat when power is applied thereto; and a plurality of heat transfer pipes tightly coupled to the concave and convex metal plate between the ridges and valleys of the concave and convex metal plate to reinforce strength of the concave and convex metal plate and allowing the heating cable to be sequentially inserted into the heat transfer pipes to transfer the heat generated from the heating cable to the concave and convex metal plate.

For example, the concave and convex metal plate may have upper parts of the ridges and lower parts of the valleys so as to be flat to ensure a wide contact area with vertically stacked adjacent woods.

In addition, the present invention may further include: a temperature sensor for detecting a temperature of the concave and convex metal plate when power is applied to the heating cable; and a control unit capable of comparing the temperature of the concave and convex metal plate detected by the temperature sensor with a preset reference temperature to cut off the power or apply the power to the heating cable.

For example, the heat transfer pipe may be formed of an aluminum material that has high thermal conductivity and prevents from being corroded by moisture discharged from the woods dried due to the heating cable and by water formed when the moisture is condensed.

Meanwhile, to this end, the present invention proposes a wood drying device including: at least one heating element interposed between vertically stacked adjacent woods to dry the woods by generating heat while supporting the adjacent woods spaced apart at a predetermined interval to form a space between the vertically stacked woods adjacent to each other, and by evenly transferring the heat to the adjacent woods via a heat transfer through heated high-temperature air and a direct heat transfer through conduction; and a housing configured to define a drying chamber for accommodating the vertically stacked woods and at least one heating element interposed between the adjacent woods, wherein the heating element includes: a concave and convex metal plate sandwiched between vertically stacked woods and having ridges and valleys alternately formed thereon; a heating cable for generating heat when power is applied thereto; and a plurality of heat transfer pipes tightly coupled to the concave and convex metal plate between the ridges and valleys of the concave and convex metal plate to reinforce strength of the concave and convex metal plate and allowing the heating cable to be sequentially inserted into the heat transfer pipes to transfer the heat generated from the heating cable to the concave and convex metal plate.

For example, the concave and convex metal plate may have upper parts of the ridges and lower parts of the valleys so as to be flat to ensure a wide contact area with vertically stacked adjacent woods.

In addition, the heating element may further include: a temperature sensor for detecting a temperature of the concave and convex metal plate when power is applied to the heating cable; and a control unit capable of comparing the temperature of the concave and convex metal plate detected by the temperature sensor with a preset reference temperature to cut off the power or apply the power to the heating cable. For example, the heat transfer pipe may be formed of an aluminum material that has high thermal conductivity and prevents from being corroded by moisture discharged from the woods dried due to the heating cable and by water formed when the moisture is condensed.

### Advantageous Effects

In regard to the heating element for the wood drying device and the wood drying device using the same according to one embodiment of the present invention as described above, the heating element is manufactured with a structure in which the heating cable is sequentially inserted into the heat transfer pipes tightly fixed to the concave and convex metal plate without causing a gap.

Accordingly, the unconstrainedly bendable heating cable can be prevented from sagging or bending due to its own weight, and interference between the heating cable and the woods can be prevented when the heating elements and the woods are alternately stacked for drying the woods, so that the heating cable can be prevented from being pulled and bending due to interference between the heating cable and the woods.

Accordingly, the concave and convex metal plate and the heat transfer pipes into which the heating cable is sequentially inserted can be always maintained in a close contact state even when an external force is applied, so that the heat conduction efficiency to the concave and convex metal plate can be prevented from being deteriorated due to the occurrence of the gap, and the working convenience during stacking the woods can be significantly improved. In addition, the heating cable can be protected by the heat transfer pipes, so that the lifespan of the heating cable can significantly extend even under poor working environment conditions.

In addition, in regard to the heating element for the wood drying device and the heating element of the wood drying device using the same according to the one embodiment of the present invention as described above, the heating element can uniformly transfer heat throughout the entire wood to dry the entire wood under uniform thermal environment conditions, so that the wood can be prevented from cracking or warping.

Accordingly, the wood can be directly dried without a natural drying process for reducing moisture content during drying the wood, so that the time for drying the woods can be significantly shortened.

In addition, in regard to the heating element for the wood drying device and the wood drying device using the same according to the one embodiment of the present invention, the heating element is manufactured with a structure in which the heating cable is sequentially inserted into the heat transfer pipes tightly fixed to the concave and convex metal plate without causing a gap, so that the unconstrainedly bendable heating cable can be prevented from sagging or bending due to its own weight, interference between the heating cable and the woods can be prevented when the heating elements and the woods are alternately stacked for drying the woods, and the heating cable can be prevented from being pulled and bending due to interference between the heating cable and the woods.

In other words, the concave and convex metal plate and the heat transfer pipes into which the heating cable is sequentially inserted can be always maintained in a close contact state even when an external force is applied, so that the heat conduction efficiency to the concave and convex metal plate can be prevented from being deteriorated due to the occurrence of the gap, and the working convenience during stacking the woods can be significantly improved. In addition, the heating cable can be protected by the heat transfer pipes, so that the lifespan of the heating cable can significantly extend even under poor working environment conditions.

In addition, in regard to the heating element for the wood drying device and the heating element of the wood drying device using the same according to the one embodiment of the present invention as described above the heating element can uniformly transfer heat throughout the entire wood to dry the entire wood under uniform thermal environment conditions, so that the wood can be prevented from cracking or warping. Accordingly, the wood can be directly dried without a natural drying process for reducing moisture content during drying the wood, so that the time for drying the woods can be significantly shortened.

In other words, it takes approximately 2 years to dry the wood when the moisture content of wood is lowered through the natural drying process and then the wood is dried using a general wood drying device in order to prevent the wood from cracking or warping during drying the wood. However, the present invention can uniformly transfer heat at the same temperature to a shell and a core of the entire front and rear surfaces of the wood, thereby preventing the wood from cracking or warping during drying the wood without a natural drying process of the wood, so that the time for drying the woods can be significantly shortened.

In addition, the heating element for the wood drying device and the wood drying device using the same according to the one embodiment of the present invention does not require welding work at all and minimizes bolting work, the assembled body frame and the assembled roof frame, which form the skeleton of the housing, can be very quickly and easily installed through the sliding fastening work using the first to sixth connecting sockets.

Meanwhile, when the sealing member formed of a waterproof material such as a waterproof sheet is coupled to the assembled body frame and the assembled roof frame to surround the assembled body frame and the assembled roof frame, the drying chamber can be formed very easily and quickly.

The heating element for the wood drying device and the housing of the wood drying device using the same according to the one embodiment of the present invention as described above may be formed in an assembled manner so as to be very easily installed and disassembled, the sealing member may be folded or rolled for storage and transportation, and the assembled body frame and the assembled roof frame may be separated into the multiple horizontal supports, vertical supports and connecting sockets, so that the housing package volume can be remarkably reduced to perform shipping and relocation very simply. The assembled body frame and the assembled roof frame, which form the skeleton of the housing, can be very quickly and easily installed only by the sliding fastening work using the first to sixth connecting sockets, except for the installation of the first vertical supports.

Meanwhile, when the sealing member formed of a waterproof material such as a waterproof sheet is coupled to the assembled body frame and the assembled roof frame to surround the assembled body frame and the assembled roof frame, the drying chamber can be formed very easily and quickly.

the heating element for the wood drying device and the housing of the wood drying device using the same according to the one embodiment of the present invention as described above may be formed in an assembled manner so as to be very easily installed and disassembled, the sealing member may be folded or rolled for storage and transportation, and the assembled body frame and the assembled roof frame may be separated into the multiple horizontal supports, vertical supports and connecting sockets, so that the housing package volume can be remarkably reduced to perform shipping and relocation very simply.

Ultimately, in regard to the heating element for the wood drying device and the wood drying device using the same according to the one embodiment of the present invention, heat loss can be minimized to significantly reduce maintenance costs, and the heating element can uniformly transfer heat throughout the entire wood to dry the entire wood under uniform thermal environment conditions, thereby preventing the wood from cracking or warping during drying and accordingly, the wood can be dried directly without a natural drying process, so that the time for drying the woods can be significantly shortened, the lifespan of the heating element can be significantly extended, the convenience of a wood stacking work for drying the woods can be greatly improved, the easy assembling and disassembling of the housing can allow very easy installation and relocation, the housing package can have the minimized volume when disassembled, and the convenience of storage and transportation can be remarkably improved, so that customer satisfaction and product reliability can be improved.

### DESCRIPTION OF DRAWINGS

FIG. 1 is an exploded perspective view for explaining a wood drying device according to the one embodiment of the present invention.

FIG. 2 is a perspective view of a heating element according to the one embodiment of the present invention.

FIG. 3 is a view showing a state in which a heating element is interposed between stacked vertically woods adjacent to each other.

FIG. 4 is a block diagram for explaining the heating element.

FIG. 5 is a view for explaining an assembled body frame and an assembled roof frame.

FIG. 6 is a view showing a state in which the woods and the heating elements are stacked inside a housing.

FIG. 7 is a view for explaining a water discharge unit.

### BEST MODE

### Mode for Invention

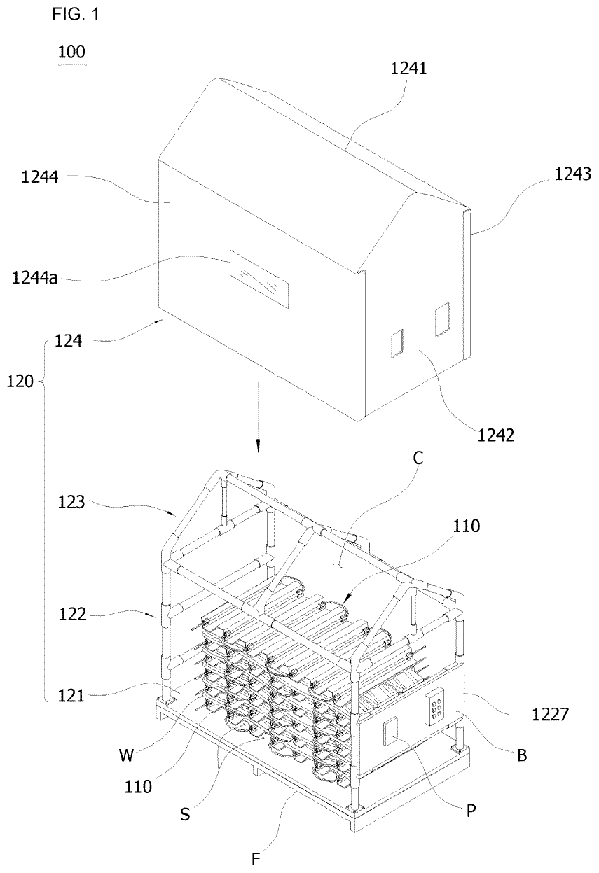

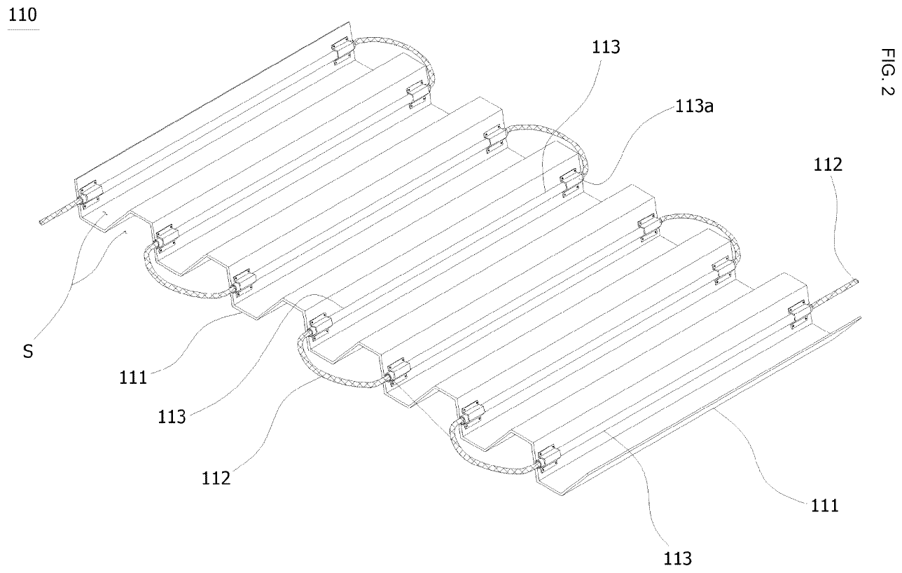

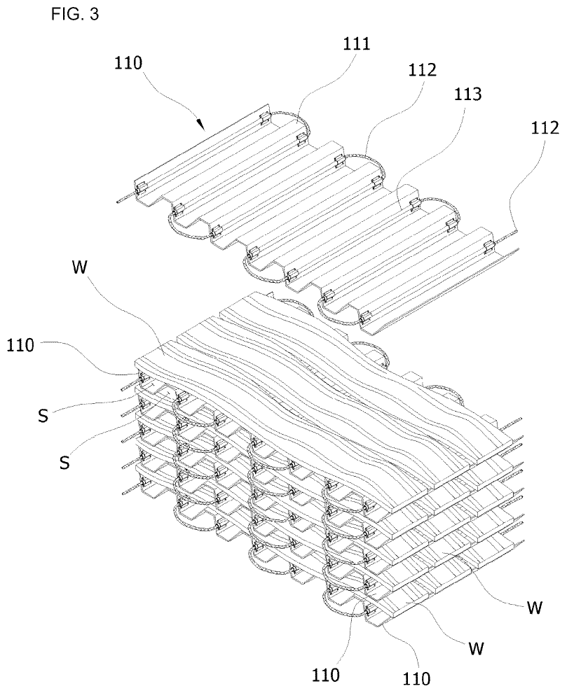

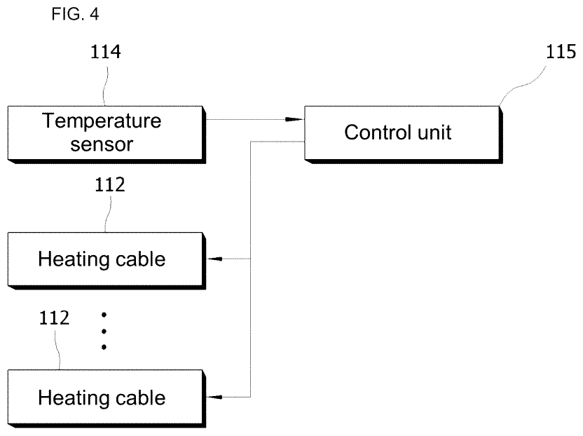

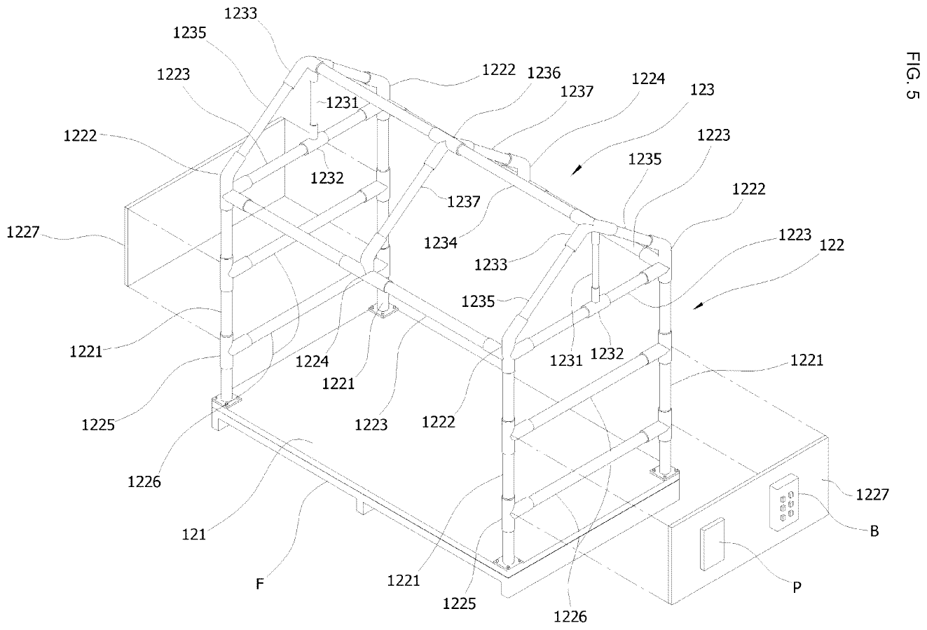

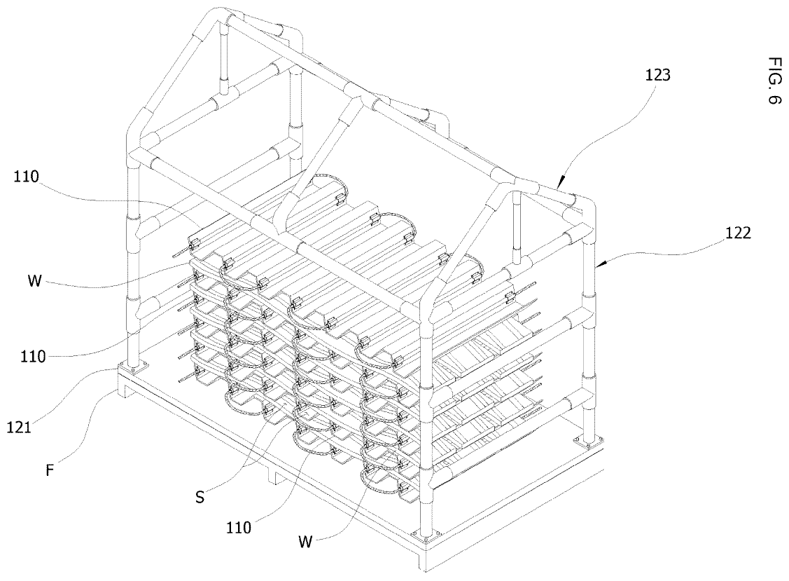

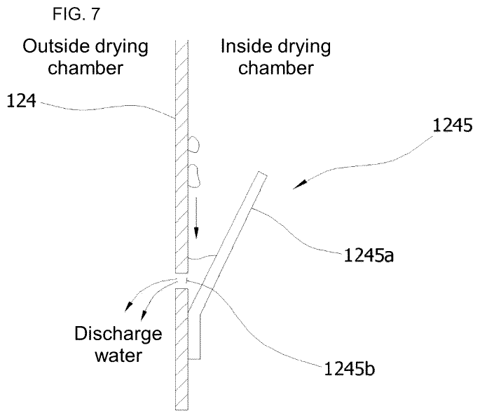

Referring to FIGS. 1 to 7, a wood drying device 100 according to the one embodiment of the present invention may include a heating element 110 and a housing 120.

At least one heating element 110 may be interposed between vertically stacked woods W adjacent to each other so as to dry the woods W by generating heat while supporting the adjacent woods W spaced apart at a predetermined interval to form a space S between the vertically stacked woods W adjacent to each other, and by evenly transferring the heat to the adjacent woods W via a heat transfer through heated high-temperature air and a direct heat transfer through conduction.

For example, the heating element 110 may include a concave and convex metal plate 111, a heating cable 112, and a heat transfer pipe 113.

The concave and convex metal plate 111 may be folded such that a plurality of ridges and valleys are formed alternately.

It is preferable that the concave and convex metal plate 111 be formed of a metal, such as steel, copper, stainless steel or aluminum, having high rigidity as well as good heat conduction efficiency.

The above concave and convex metal plate 111 may be interposed between vertically stacked woods W to support the vertically stacked woods W in a predetermined interval state. When the concave and convex metal plate 111 is interposed between the vertically stacked woods W, a space S may be defined between the vertically stacked woods W by the ridges and valleys of the concave and convex metal plate 111.

Accordingly, when power is applied to the heating cable 112 to generate heat and moisture is generated from the woods W, the moisture generated from the woods W is allowed to be discharged through the ridges or the valleys, and simultaneously, the heat generated from the heating cable 112 is allowed to be evenly transferred to the woods W.

Meanwhile, it is desirable that the upper part of the ridge and the lower part of the valley of the concave and convex metal plate 111, which come into contact with the vertically stacked adjacent woods W be formed flat to ensure a wide contact area with the woods W and come into close contact with the woods W so as to improve the thermal conductivity.

For example, it is preferable that the ridges and valleys of the concave and convex metal plate 111 be formed in a trapezoidal section.

The heating cable 112 is disposed in a plurality of space S formed by the ridges and valleys of the concave and convex metal plate 111 and, when power is applied thereto, uniformly transfers heat to the entire adjacent woods W via a heat transfer through high-temperature heated air to the woods W and a direct heat transfer through conduction to the concave and convex metal plate 111, thereby drying the woods W.

For example, as the heating cable 112, a heating cable 112 in the form of a chrome-plated wire wrapped with a stainless steel wire may be used.

Meanwhile, both ends of the heating cable 112 are connected to a power source.

The heat transfer pipes 113 may be arranged in multiple pieces at a predetermined interval and come into close contact with the concave and convex metal plate 111 without a gap, and then may be fixed to the concave and convex metal plate 111 through a plurality of fixing members 113a.

The heating cable 112 arranged in the space S of the concave and convex metal plate 111 may be sequentially inserted into the above heat transfer pipes 113.

In other words, the heating cable 113 may be sequentially inserted into the heat transfer pipes 112 arranged on the concave and convex metal plate 111 at a predetermined interval and tightly fixed to the concave and convex metal plate 111 without causing a gap.

The heat transfer pipes 113 are arranged and fixed at a predetermined interval onto the concave and convex metal plate 111, so that strength of the concave and convex metal plate 111 may be significantly reinforced.

In addition, the heating cable 112 is sequentially inserted into the heat transfer pipes 113 to prevent the heating cable 112 from being exposed to the space S formed between the vertically stacked woods W, thereby protecting the heating cable 112, and accordingly, the heating cable 112 is prevented from being damaged when woods W are stacked for drying the woods W or when the stacked woods W are dismantled after completion of drying, so that the lifespan of the heating cable 112 may significantly extend. In addition, the work of stacking the woods W or dismantling the stacked woods W is easily performed, so that work efficiency during drying the woods may be significantly improved.

Further, the heat transfer pipes 113 are tightly fixed to the concave and convex metal plate 111 without causing the gap, so that heat conduction efficiency from the heating cable 112 inserted therein to the concave and convex metal plate 111 may be significantly improved.

More specifically, when only the heating cable 112 itself is fixed using multiple fixing members 113a without installing the heat transfer pipes 113 on the concave and convex metal plate 111, the heating cable 112 may sag or bend caused by self-weight of the heating cable 112 due to the characteristics of the unconstrainedly bendable heating cable 112, thereby generating a gap between the heating cable 112 and the concave and convex metal plate 111, and accordingly a phenomenon occurs in which the heat conduction efficiency from the heating cable 112 to the concave and convex metal plate 111 is significantly deteriorated.

In addition, when the heating elements 110 and the woods W are alternately stacked in the vertical direction to dry the woods W, interference may occur between the woods W and the heating cable 112. Thus, when the heating cable 112 is pulled, the gap between the concave and convex metal plate 111 and the heating cable 112 becomes larger, thereby further deteriorating the heat conduction efficiency, and accordingly, workability during stacking the woods W may also be significantly deteriorated, causing many difficulties in wood lamination.

In contrast, according to the present invention, the heating cable 112 is sequentially inserted into the heat transfer pipes 113 tightly coupled to the concave and convex metal plate 111 without causing a gap, so that the heat conduction efficiency from the heating cable 112 to the concave and convex metal plate 111 may be significantly improved. In addition, interference does not occur between the woods W and the heating cable 112 even when the heating elements 110 and the woods W are alternately stacked in the vertical direction for drying the woods W, thereby resolving problems caused by the interference between the woods W and the heating cable 112 that occurs when stacking the woods W, so that the convenience of wood lamination work for drying the woods W may be significantly improved.

Further, according to the present invention, the heating cable 112 is sequentially inserted into the heat transfer pipes 113, so that electromagnetic waves generated from the heating cable 112 during drying the woods W may be blocked.

It is preferable that the heat transfer pipe 113 be formed of an aluminum material that has high thermal conductivity and does not be corroded by moisture discharged from the woods W dried due to the heating cable 112 and by water formed when the moisture is condensed.

In addition, the heating element 110 may further include a temperature sensor 114 and a control unit 115.

The temperature sensor 114 may detect a heating temperature of the concave and convex metal plate 111 when power is applied to the heating cable 112.

The control unit 115 is configured to compared the temperature of the concave and convex metal plate 111 detected by the temperature sensor 114 with a preset reference temperature to cut off or apply the power to the heating cable 112, thereby controlling the temperature.

For example, the control unit 115 may control the heating temperature of the concave and convex metal plate 111 by cutting off the power to the heating cable 112 to decrease the heating temperature when the heating temperature of the concave and convex metal plate 111 detected by the temperature sensor 114 is determined to be higher than the preset reference temperature, and may control the heating temperature of the heating cable 112 by applying the power to the heating cable 112 to increase the heating temperature when the heating temperature of the concave and convex metal plate 111 detected by the temperature sensor 114 is determined to be lower than the preset reference temperature.

Further, the heating element 110 may further include a display unit (not shown) connected to the control unit 115 to display the temperature of the concave and convex metal plate 111 detected by the temperature sensor 114 and transmitted to the control unit.

The housing 120 is configured to define a drying chamber C for accommodating the vertically stacked woods W and at least one heating element 110 interposed between the adjacent woods W.

The housing 120 is configured to condense water vapor generated from the woods W into water when the heating cable 112 of the heating element 110 operates to increase the temperature within the drying chamber C defined by the housing.

Meanwhile, the housing 120 may be assembled and disassembled without welding work, and may be manufactured in an assembled form capable of minimizing the volume when being disassembled to easily store and transport the housing.

For example, the housing 120 may include an insulating floor plate 121, an assembled body frame 122, an assembled roof frame 123, and a sealing member 124.

The insulating floor plate 121 may be installed on a top of a base frame F. Meanwhile, vertically stacked woods W to be dried with a plurality of heating elements 110 interposed therebetween may be placed on a top of the insulating floor plate 121.

It is preferable that the insulating floor plate 121 be formed of heat-resistant urethane. The assembled body frame 122 includes a plurality of first vertical supports 1221 detachably installed by a fixing members at corners of an upper surface of the insulating floor plate 121 to allow the woods W and the heating elements 110 to be accommodated therein, in which first horizontal supports 1223 may be detachably connected to upper end parts of the first vertical supports 1221 adjacent to each other through first connecting sockets 1222. Even when the supports are detachably connected, the supports may be fastened and fixed by bolts that have an end passing through the first connecting socket 1222 and pressurizing the first vertical support 1221, so as to prevent mutual movement between the first connecting socket 1222 and the first vertical support 1221 while the first vertical support 1221 is inserted into the first connecting socket 1222. The same fixing scheme may be applied to the combination between the connecting sockets and the supports described below.

In addition, the assembly body frame 122 may further include a second connecting socket 1224.

The second connecting socket 1224 is used when the first horizontal support 1223 positioned at a front and a rear of the assembled body frame 122 is formed by dividing into multiple pieces. The second connecting sockets 1224 may be disposed between the first horizontal supports 1223 divided into multiple pieces to allow neighboring first horizontal supports 1223 to be detachably connected and extend to a desired length. Further, the assembled body frame 122 may further include a third connecting socket 1225 and an auxiliary horizontal support 1226.

The third connecting socket 1225 is used when the first vertical support 1221 of the assembled body frame 122 is formed by dividing into multiple pieces. The third connecting sockets 1225 may be disposed between the first vertical supports 1221 divided into multiple pieces to allow neighboring first vertical supports 1221 to be detachably connected and extend to a desired length.

The multiple auxiliary horizontal supports 1226 may be disposed on both sides of the assembled body frame 122 to have both ends detachably connected to the adjacent third connecting sockets 1225.

Meanwhile, the auxiliary horizontal support 1226 may be installed thereon with a fixed panel 1227 formed of a material such as polycarbonate, in which a control box B provided with a control unit 115 and a power connection unit P connected to the heating element 110 are installed.

The assembly roof frame 123 may have second vertical supports 1231 detachably connected to the first horizontal supports 1223 positioned at ends of both tops of the assembled body frame 122 through fourth connecting sockets 1232, respectively. Both ends of a second horizontal support 1234 may be detachably connected to tops of the pair of second vertical supports 1231 through the fifth connecting sockets 1233, respectively. Both ends of a diagonal support 1235 may be detachably connected to the fifth connecting socket 1233 and the first connecting socket 1222 of the assembled body frame 122.

In addition, the assembled roof frame 123 may further include a sixth connecting socket 1236 and an auxiliary diagonal support 1237.

The sixth connecting socket 1236 is used when the second horizontal support 1234 is formed by dividing into multiple pieces. The sixth connecting socket 1236 may be disposed between the second horizontal supports 1224 divided into multiple pieces to allow neighboring second horizontal supports 1224 to be detachably connected and extend to a desired length.

The auxiliary diagonal support 1237 has both ends detachably connected to the second connecting socket 1224 connecting the first horizontal supports 1223 divided into multiple pieces and the sixth connecting socket 1236 connecting the second horizontal supports 1234 divided into multiple pieces, so that the assembled roof frame 123 may be reinforced.

Meanwhile, although not shown in the drawings, it is preferable that the assembled body frame 122 and the assembled roof frame 123 insulate outer surfaces using insulating materials to prevent heat loss when heat generated from the heating element 110 is transferred to the assembled body frame 122 and the assembled roof frame 123, or when the assembled body frame 122 and the assembled roof frame 123 are cooled by external cold air.

The sealing member 124 is configured to be connected to the assembled body frame 122 and the assembled roof frame 123 to surround the assembled body frame 122 and the assembled roof frame 123, thereby sealing the internal space of the drying chamber C defined by the assembled body frame 122 and the assembled roof frame 123, and it is preferable that the sealing member 124 be formed of a waterproof material such as a waterproof sheet.

For example, the sealing member 124 may include a roof sealing part 1241, side sealing parts 1242, a rear sealing 1243, and a front sealing part 1244.

The roof sealing member 1241 may be coupled to the assembled roof frame 123 so as to surround the assembled roof frame 123.

The side sealing parts 1242 extend from lower ends of both sides of the roof sealing part 1241 and are coupled to the assembled body frame 122 so as to seal both sides of the assembled body frame 122.

The rear sealing part 1243 extends from a rear lower end of the roof sealing part 1241 and is coupled to the assembled body frame 122 so as to seal a rear portion of the assembled body frame 122, and may be coupled to the pair of side sealing parts 1242 by separable coupling members (not shown).

For example, the rear sealing part 1243 may be coupled to the pair of side sealing parts 1242 by coupling members such as a Velcro tape so as to be separated and coupled.

The front sealing part 1244 extends from a front lower end of the roof sealing part 1241 and is coupled to the assembled body frame 122 so as to seal a front portion of the assembled body frame 122, and may be coupled to the pair of side sealing parts 1242 by separable coupling members (not shown).

For example, like the rear sealing part 1243, the front sealing part 1244 may also be coupled to the pair of side sealing parts 1242 by coupling members such as a Velcro tape so as to be separated and coupled.

Meanwhile, the front sealing part 1244 may be provided with a transparent window 1244a capable of checking a state of the woods disposed and dried inside the drying chamber C.

In addition, although not shown in the drawings, the sealing member 124 may further include a fixing member.

The fixing member is configured to fix the front sealing part 1244 provided at the lower end of the roof sealing part 1241 and rolled up toward the roof sealing part 1241 to form an entrance for introducing woods W into the drying chamber C or discharging dried woods W outside the drying chamber C.

For example, a Velcro tape may be used as the fixing member.

Further, the sealing member 124 may further include a water discharge unit 1245.

The water discharge unit 1245 is provided at a lower end of an inner side of the sealing member 124 to discharge water, which is formed from moisture discharged when the heating element 110 heats the woods W and condensed on the inner side of the sealing member 124 and flows down along the sealing member 124, to the outside of the drying chamber C.

For example, the water discharge unit 1245 may include a pocket forming member 1245a and a discharge hole 1245b.

The pocket forming member 1245a is attached to a lower portion of the inner surface of the sealing member 124 so as to form a pocket in the lower portion of the inner surface of the sealing member 124, so that water condensed on the inner surface of the sealing member 124 and flowing down may be allowed to accumulate in the pocket.

The multiple discharge holes 1245b are formed at a predetermined interval in the sealing member 124 so as to be arranged on a lower side of the pocket forming member 1245a. Thus, when the water flows down along the inner surface of the sealing member 124 toward the pocket forming member 1245a, the water may be discharged outside the sealing member 124, that is, outside the drying chamber C through the discharge holes 1245b.

A process of installing the housing and a process of drying woods using the wood drying device will be described with reference to FIGS. 1 to 7 again.

First, in order to install the housing 120 of the wood drying device 100 according to the one embodiment of the present invention, the insulating floor plate 121 is installed on the top of the base frame F and then the assembled body frame 122 is installed on the top of the insulating floor plate 121.

More specifically, the first vertical support members 1221 are installed using the fixing members at corners, respectively, of the upper surface of the insulating floor plate 121 installed on the top of the base frame F.

The first vertical support 1221 may be divided into multiple pieces and detachably connected by the third connecting sockets 1225 to a required length.

Meanwhile, the first horizontal support 1223 is detachably connected to the upper ends of the first vertical supports 1221 adjacent to each other through the first connecting sockets 1222.

The first horizontal support 1223 positioned at the front and rear of the assembled body frame 122 may be formed by dividing into multiple pieces, and the first horizontal supports 1223 formed by dividing into the multiple pieces may be detachably connected to a desired length by the second connecting sockets 1224.

In addition, the both ends of the auxiliary horizontal support 1226 may be detachably connected to the third connecting sockets 1225 adjacent to each other to be positioned on both sides of the assembled body frame 122, and a fixed panel (1227) installed therein with the control box B including the control unit 115 and the power connection unit P may be installed on the auxiliary horizontal support 1226.

Thereafter, the assembled roof frame 123 is detachably connected and installed to the upper portion of the assembled body frame 122.

More specifically, the second vertical supports 1231 are detachably connected to the first horizontal supports 1223 positioned at the upper ends of the both side of the assembled body frame 122, respectively, through the fourth connecting sockets 1232. In addition, the both ends of the second horizontal support 1234 are detachably connected to the tops of the second vertical supports 1231 through the fifth connecting sockets 1233, respectively.

The second horizontal support 1234 may be divided into multiple pieces and detachably connected by the sixth connecting sockets 1236 to a required length.

In addition, the both ends of the diagonal support 1235 are detachably connected to the fifth connecting socket 1233 and the first connecting socket 1222 of the assembled body frame 122.

Further, the auxiliary diagonal support 1237 is detachably connected to the second connecting socket 1224 connecting the first horizontal supports 1223 divided into multiple pieces and the sixth connecting socket 1236 connecting the second horizontal supports 1234 divided into multiple pieces, so that the assembled roof frame 123 may be reinforced.

When the assembly of the assembled body frame 122 and the assembled roof frame 123 is completed as described above, the sealing member 124 is coupled to the assembled body frame 122 and the assembled roof frame 123 to surround the assembled body frame 122 and the assembled roof frame 123, and thus the assembly of the housing 120 is completed.

The above-described housing 120 of the wood drying device 100 according to the one embodiment of the present invention does not require welding work at all and minimizes bolting work, and the housing 120 may be installed very quickly and easily by sliding fastening using multiple connecting sockets to form the drying chamber C.

In order to dry woods W using the wood drying device 100 formed therein with the drying chamber C after installing the housing 120 very quickly and easily in the above manner, first, the front sealing part 1244 of the sealing member 124 is rolled up and fixed to the lower end portion of the roof sealing part 1241 by using multiple fixing members such as Velcro tapes, so that a front portion of the drying chamber C is opened to form the entrance.

After the front portion of the drying chamber C formed by the housing 120 is opened to form the entrance in the above manner, the woods W and the heating element 110 are moved into the drying chamber C formed by the housing 120 through the entrance and are stacked above the insulating floor plate 121.

It is preferable to vertically stack the multiple woods W with the heating elements 110 interposed therebetween, such that the space S is formed between vertically stack adjacent woods W above the insulating floor plate 121 inside the drying chamber C.

The heating element 110 is configured such that the multiple heat transfer pipes 113 are disposed at a predetermined interval on the concave and convex metal plate 111 and tightly fixed to the concave and convex metal plate 111 without a gap, and the heating cable 112 is sequentially inserted into the multiple heat transfer pipes 113 disposed at the predetermined interval on the concave and convex metal plate 111 and tightly fixed thereto without the gap.

Accordingly, when the work of alternately stacking the multiple woods W and the multiple heating elements 110 is performed, the heating cable 112 is prevented from being exposed to the space S formed between the woods W stacked vertically.

In other words, when the heating cable 112 is surrounded by the heat transfer pipes 113 to prevent the heating cable 112 from being exposed to the space S formed between the woods W, the heating cable 112 is prevented from being damaged when woods W are stacked for drying the woods W or when the stacked woods W are dismantled after completion of drying, so that the lifespan of the heating cable 112 may significantly extend, and the work of stacking the woods W or dismantling the stacked woods W may be performed very quickly and easily.

In addition, the heating cable 112 is prevented from being pulled and sagging or bending due to interference between the heating cable 112 and the woods W when the woods W are stacked, thereby completely preventing a gap occurring between the concave and convex metal plate 111 and the heating cable 112, so that the thermal conductivity efficiency may also be significantly improved.

After the multiple woods W and the heating elements 110 are stacked above the insulating floor plate 121 in the above manner, the front sealing part 1244 is unfolded by releasing the fixation of the front sealing part 1244 rolled up toward the roof sealing part 1241 and fixed by the fixing members, and then the both sides of the front sealing part 1244 are coupled to the pair of side sealing parts 1242 by using the coupling members, thereby sealing the drying chamber C.

Thereafter, when the heating cable 112 is heated by applying power to the heating element 110, the heat generated from the heating cable 112 is transferred to the heat transfer pipe 113, and the heated air is evenly transferred, through the heat transfer pipes 113, to the upper and lower surfaces of the adjacent woods W via the space S arranged between the woods W and formed by the ridges and valleys of the concave and convex metal plates 111 interposed between the vertically stacked adjacent woods W.

In addition, drying of the woods W may also be promoted by radiant heat generated by the heating cable 112, the heat transfer pipes 113, and the concave and convex metal plate 111, so that drying efficiency of the woods W may be further improved. In addition, when the power is applied to the heating cable 112 to apply the heat to the woods W and moisture is discharged from the woods W, moisture contained in air inside the drying chamber C condenses on the inner surface of the sealing member 124.

The moisture condensed on the inner surface of the sealing member 124 flows down along the sealing member 124, and is collected in the pocket forming member 1245a of the water discharge unit 1245 provided at the lower portion of the inner surface of the sealing member 124, and the water is discharged outside the sealing member 124 through the discharge hole 1245b.

The temperature sensor 114 detects a temperature of the concave and convex metal plate 111 of each heating element 110 interposed between the vertically stacked adjacent woods W and transmits the temperature to the control unit 115. The control unit 115 is configured to control a temperature inside the drying chamber C by comparing the heating temperature of the concave and convex metal plate 111 with a preset reference temperature, and cutting off the power supplied to the heating cable 112 when the heating temperature of the concave and convex metal plate 111 is determined to be higher than the reference temperature, or applying the power to the heating cable 112 when the heating temperature of the concave and convex metal plate 111 is determined to be lower than the reference temperature.

In regard to the heating element for the wood drying device 100 and the wood drying device using the same according to the one embodiment of the present invention as described above, the heating element 110 is manufactured with a structure in which the heating cable 112 is sequentially inserted into the heat transfer pipes 113 tightly fixed to the concave and convex metal plate 111 without causing a gap, so that the unconstrainedly bendable heating cable 112 may be prevented from sagging or bending due to its own weight, and interference between the heating cable 112 and the woods W may be prevented when the heating elements and the woods W are alternately stacked for drying the woods W, so that the heating cable 112 may be prevented from being pulled and bending due to interference between the heating cable 112 and the woods W.

In other words, the concave and convex metal plate 111 and the heat transfer pipes 113 into which the heating cable 112 is sequentially inserted are always maintained in a close contact state even when an external force is applied, so that the heat conduction efficiency to the concave and convex metal plate 111 may be prevented from being deteriorated due to the occurrence of the gap, and the working convenience during stacking the woods W may be significantly improved. In addition, the heating cable 112 may be protected by the heat transfer pipes 113, so that the lifespan of the heating cable 112 may significantly extend even under poor working environment conditions.

In addition, the heating element for the wood drying device according to the one embodiment of the present invention as described above and the heating element 110 of the wood drying device 100 using the same may uniformly transfer heat throughout the entire wood W to dry the entire wood W under uniform thermal environment conditions, so that the wood W may be prevented from cracking or warping.

Accordingly, the wood W may be directly dried without a natural drying process for reducing moisture content during drying the wood, so that the time for drying the woods W may be significantly shortened.

In other words, it takes approximately 2 years to dry the wood W when the moisture content of wood W is lowered through the natural drying process and then the wood W is dried using a general wood drying device to prevent the wood W from cracking or warping during drying the wood W, whereas the present invention may uniformly transfer heat at the same temperature to a shell and a core of the entire front and rear surfaces of the wood W, thereby preventing the wood W from cracking or warping during drying the wood W without a natural drying process of the wood W, so that the time for drying the woods W may be significantly shortened.

In addition, in regard to the heating element for the wood drying device and the wood drying device 100 using the same according to the one embodiment of the present invention, the assembled body frame 122 and the assembled roof frame 123, which form the skeleton of the housing, may be very quickly and easily installed by the sliding fastening work using the multiple connecting sockets, except for the installation of the first vertical supports 1221.

Meanwhile, when the sealing member 124 formed of a waterproof material such as a waterproof sheet is coupled to the assembled body frame 122 and the assembled roof frame 123 to surround the assembled body frame 122 and the assembled roof frame 123), the drying chamber C may be formed very easily and quickly.

The heating element for the wood drying device according to the one embodiment of the present invention as described above and the housing 120 of the wood drying device 100 using the same may be formed in an assembled manner so as to be very easily installed and disassembled, the sealing member 124 may be folded or rolled for storage and transportation, and the assembled body frame 122 and the assembled roof frame 123 may be separated into the multiple horizontal supports, vertical supports and connecting sockets, so that the housing package volume is remarkably reduced to perform shipping and relocation very simply.

### INDUSTRIAL APPLICABILITY

The present invention may be used in the field of wood drying technology that evaporates and dries moisture contained in woods.

1. A heating element for a wood drying device, the heating element comprising:
a concave and convex metal plate sandwiched between vertically stacked woods and having ridges and valleys alternately formed thereon;
a heating cable for generating heat when power is applied thereto; and
a plurality of heat transfer pipes tightly coupled to the concave and convex metal plate between the ridges and valleys of the concave and convex metal plate to reinforce strength of the concave and convex metal plate and allowing the heating cable to be sequentially inserted into the heat transfer pipes to transfer the heat generated from the heating cable to the concave and convex metal plate.

2. The heating element of claim 1, wherein the concave and convex metal plate is configured such that the ridge has a flat top and the valley has a flat bottom to ensure a wide contact area with vertically stacked adjacent woods.

3. The heating element of claim 1, further comprising:
a temperature sensor for detecting a temperature of the concave and convex metal plate when power is applied to the heating cable; and
a control unit capable of comparing the temperature of the concave and convex metal plate detected by the temperature sensor with a preset reference temperature to cut off the power or apply the power to the heating cable.

4. The heating element of claim 1, wherein the heat transfer pipes is formed of an aluminum material having high thermal conductivity and prevented from being corroded by moisture discharged from the woods dried due to the heating cable and by water formed when the moisture is condensed.

5. A wood drying device comprising:
at least one heating element interposed between vertically stacked adjacent woods to dry the woods by generating heat while supporting the adjacent woods spaced apart at a predetermined interval to form a space between the vertically stacked woods adjacent to each other, and by evenly transferring the heat to the adjacent woods via a heat transfer through heated high-temperature air and a direct heat transfer through conduction; and
a housing configured to define a drying chamber for accommodating the vertically stacked woods and at least one heating element interposed between the adjacent woods, wherein
the heating element includes:
a concave and convex metal plate sandwiched between vertically stacked woods and having ridges and valleys alternately formed thereon;
a heating cable for generating heat when power is applied thereto; and
a plurality of heat transfer pipes tightly coupled to the concave and convex metal plate between the ridges and valleys of the concave and convex metal plate to reinforce strength of the concave and convex metal plate and allowing the heating cable to be sequentially inserted into the heat transfer pipes to transfer the heat generated from the heating cable to the concave and convex metal plate.

6. The wood drying device of claim 5, wherein the concave and convex metal plate is configured such that the ridge has a flat top and the valley has a flat bottom to ensure a wide contact area with vertically stacked adjacent woods.

7. The wood drying device of claim 5, wherein the heating element further includes:
a temperature sensor for detecting a temperature of the concave and convex metal plate when power is applied to the heating cable; and
a control unit capable of comparing the temperature of the concave and convex metal plate detected by the temperature sensor with a preset reference temperature to cut off the power or apply the power to the heating cable.

8. The wood drying device of claim 5, wherein the heat transfer pipes is formed of an aluminum material having high thermal conductivity and prevented from being corroded by moisture discharged from the woods dried due to the heating cable and by water formed when the moisture is condensed.
